(19) United States
(12) Patent Application Publication
(10) Pub. No.: US 2002/0174882 A1
(43) Pub. Date: Nov. 28, 2002

(54) Substrate processing apparatus and substrate processing method

(75) Inventor: Masahiro Kimura, Kyoto (JP)

Correspondence Address: OSTROLENK FABER GERB & SOFFEN, 1180 AVENUE OF THE AMERICAS, NEW YORK, NY, 100368403

(73) Assignee: Dainippon Screen Mfg. Co., Ltd.

(21) Appl. No.: 10/150,966

(22) Filed: May 17, 2002

(30) Foreign Application Priority Data
May 25, 2001 (JP) 2001-157120
May 28, 2001 (JP) 2001-158694
Jun. 8, 2001 (JP) 2001-173805
Mar. 25, 2002 (JP) 2002-82755
Mar. 25, 2002 (JP) 2002-82891
Mar. 25, 2002 (JP) 2002-83278

(51) Int. Cl. B08B 7/04

(52) U.S. Cl. 134/21; 134/30; 134/61; 134/902; 134/95.2; 134/32

(57) ABSTRACT

After a substrate is completely cleaned in a processing bath, de-ionized water is discharged from the processing bath while a supply nozzles supplies nitrogen gas. The supply nozzle discharges IPA vapor toward an opening of the processing bath while the substrate is held in the processing bath. Thus, the IPA vapor flows into the processing bath for drying the substrate held in the processing bath. Consequently, it follows that the IPA vapor may sufficiently be supplied to the processing bath having a smaller volume than a chamber, whereby consumption of vapor of an organic solvent can be reduced.

### BACKGROUND OF THE INVENTION

1. Field of the Invention

The present invention relates to a substrate processing technique for drying a semiconductor substrate, a glass substrate for a liquid crystal display, a glass substrate for a photomask or a substrate for an optical disk (hereinafter simply referred to as “substrate”) completely cleaned with de-ionized water (DI water).

2. Description of the Background Art

In steps of manufacturing a substrate, a substrate processing apparatus is generally employed for successively processing the substrate with a chemical solution such as hydrofluoric acid, cleaning the same with DI water and thereafter supplying vapor of an organic solvent such as isopropyl alcohol (hereinafter abbreviated as “IPA”) around the substrate for drying the same. Following recent development of complication and refinement of the structure of a pattern formed on the substrate, in particular, a pull-up drying system pulling up the substrate from the DI water while supplying IPA vapor is becoming the mainstream.

In a conventional substrate processing apparatus employing the pull-up drying system, a chamber 90 contains a processing bath 92 performing cleaning with DI water, as shown in FIG. 25. After a substrate W is completely cleaned in the processing bath 92, a hoisting mechanism 93 pulls up the substrate W from the processing bath 92 while supplying nitrogen gas into the chamber 90 and supply nozzles 91 thereafter discharge IPA vapor along arrows F19, as shown in FIG. 25. Thus, it follows that the chamber 90 is filled up with the IPA vapor so that IPA is condensed on the substrate W and dried thereby during the substrate W.

However, the aforementioned substrate processing apparatus employing the pull-up drying system must supply the IPA vapor into the overall chamber 90, and it cannot be said that the IPA vapor is efficiently supplied to the substrate W, disadvantageously leading to remarkable consumption of IPA.

### SUMMARY OF THE INVENTION

The present invention is directed to a substrate processing apparatus.

According to the present invention, this substrate processing apparatus drying a substrate after cleaning the substrate with a fluid includes a processing bath storing a liquid for immersing the substrate in the liquid and cleaning the substrate, holding device holding the substrate in said processing bath, discharge device discharging the liquid stored in the processing bath while the holding device holds the substrate in the processing bath and inert gas is introduced into the processing bath, and introduction device introducing an organic solvent into the processing bath while the holding device holds the substrate in the processing bath from which the liquid is discharged by the discharge device. Therefore, vapor of the organic solvent is introduced into the processing bath, whereby consumption of the vapor of the organic solvent can be reduced, while liquid is discharged while the substrate is held in the processing bath, whereby particles can be inhibited from re-adhering to the substrate.

According to a preferred embodiment of the present invention, the discharge device discharges the liquid stored in the processing bath while introducing inert gas into the processing bath. Therefore, liquid is discharged while the inert gas is introduced into the processing bath before introducing the organic solvent into the processing bath, whereby it is possible to properly start drying the substrate with vapor of the organic solvent.

According to the present invention, this substrate processing apparatus drying a substrate after cleaning the substrate with a fluid includes a processing bath storing a liquid for immersing the substrate in the liquid and cleaning the substrate, holding device holding the substrate in the processing bath, discharge device discharging the liquid stored in the processing bath while the holding device holds the substrate in the processing bath, organic solvent supply device supplying an organic solvent for forming a jet area of the organic solvent on a position above the processing bath and pull-up device pulling up the substrate from the processing bath from which the liquid is discharged by the discharge device and passing the substrate through the jet area of the organic solvent. Therefore, the substrate passes through the jet area of the organic solvent when pulled up, whereby consumption the organic solvent can be reduced, and liquid is discharged while the substrate is held in the processing bath, whereby particles can be inhibited from re-adhering to the substrate.

According to a preferred embodiment of the present invention, this substrate processing apparatus further includes inert gas introduction device introducing inert gas into the processing bath, and the discharge device discharges the liquid stored in the processing bath while the inert gas introduction device introduces the inert gas into the processing bath. Therefore, liquid is discharged while the inert gas is introduced into the processing bath before forming the jet area of the organic solvent, whereby it is possible to properly start drying the substrate with vapor of the organic solvent.

According to the present invention, this substrate processing apparatus drying a substrate after cleaning the substrate with a fluid includes a processing bath storing a liquid for immersing the substrate in the liquid and cleaning the substrate, holding device holding the substrate in the processing bath, discharge device discharging the liquid stored in the processing bath while the holding device holds the substrate in the processing bath, heating device heating inert gas supplied from an inert gas source for generating high-temperature inert gas, and inert gas introduction device introducing inert gas into the processing bath while the holding device holds the substrate in the processing bath from which the liquid is discharged by the discharge device. Therefore, the high-temperature inert gas is introduced into the processing bath, whereby no organic solvent is used or usage of an organic solvent can be reduced in substrate processing, and liquid is discharged while the substrate is held in the processing bath, whereby particles can be inhibited from re-adhering to the substrate.

According to a preferred embodiment of the present invention, the discharge device discharges the liquid stored in the processing bath while the inert gas introduction device introduces the high-temperature inert gas into the processing bath. Therefore, liquid is discharged while the high-temperature inert gas is introduced into the processing bath, whereby it is possible to properly start drying the substrate with the high-temperature inert gas.

The present invention is also directed to a substrate processing method drying a substrate after cleaning the substrate with a fluid.

Accordingly, an object of the present invention is to provide a substrate processing technique capable of reducing usage of an organic solvent in substrate processing.

The foregoing and other objects, features, aspects and advantages of the present invention will become more apparent from the following detailed description of the present invention when taken in conjunction with the accompanying drawings. dr

### BRIEF DESCRIPTION OF THE DRAWINGS

FIG. 1 is a front elevational view of a substrate processing apparatus according to a first embodiment of the present invention;

FIG. 2 is a sectional view taken along the line II-II in FIG. 1;

FIG. 3 is a model diagram showing the structures of pipes etc. of the substrate processing apparatus;

FIG. 4 is a flow chart showing the operation of substrate processing in the substrate processing apparatus;

FIGS. 5 to 9 illustrate the way of the processing in the substrate processing apparatus;

FIG. 10 is a front elevational view of a substrate processing apparatus according to a second embodiment of the present invention;

FIG. 11 is a sectional view taken along the line XI-XI in FIG. 10;

FIG. 12 is a model diagram showing the structures of pipes etc. of the substrate processing apparatus;

FIG. 13 is a flow chart showing the operation of substrate processing in the substrate processing apparatus;

FIGS. 14 to 17 illustrate the way of the processing in the substrate processing apparatus;

FIG. 18 is a model diagram showing the structures of pipes etc. of a substrate processing apparatus according to a third embodiment of the present invention;

FIG. 19 is a flow chart showing the operation of substrate processing in the substrate processing apparatus;

FIGS. 20 to 24 illustrate the way of the processing in the substrate processing apparatus; and

FIG. 25 illustrates substrate drying processing according to prior art.

### DESCRIPTION OF THE PREFERRED EMBODIMENTS

<First Embodiment>

<Structure of Principal Part of Substrate Processing Apparatus>

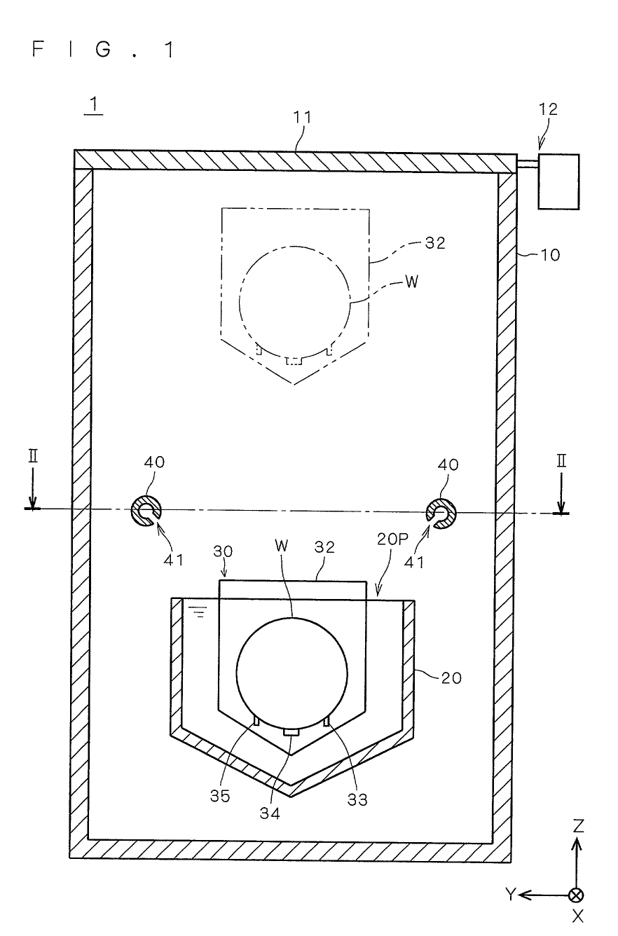

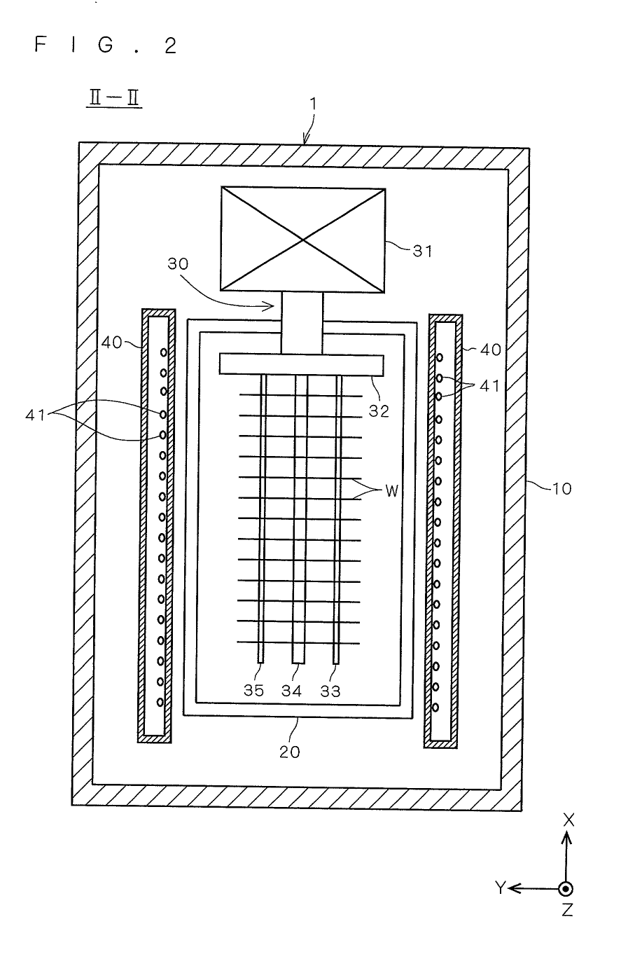

FIG. 1 is a front elevational view of a substrate processing apparatus 1 according to a first embodiment of the present invention. FIG. 2 is a sectional view taken along the line II-II in FIG. 1. An XYZ Cartesian coordinate system having an X-Y horizontal plane and a Z-axis vertical direction is properly assigned to each of FIG. 1 and subsequent drawings, in order to clarify the directional relation.

The substrate processing apparatus 1 for drying substrates W completely cleaned with DI water with IPA serving as an organic solvent mainly comprises a chamber 10, a processing bath 20, a hoisting mechanism 30 and supply nozzles 40.

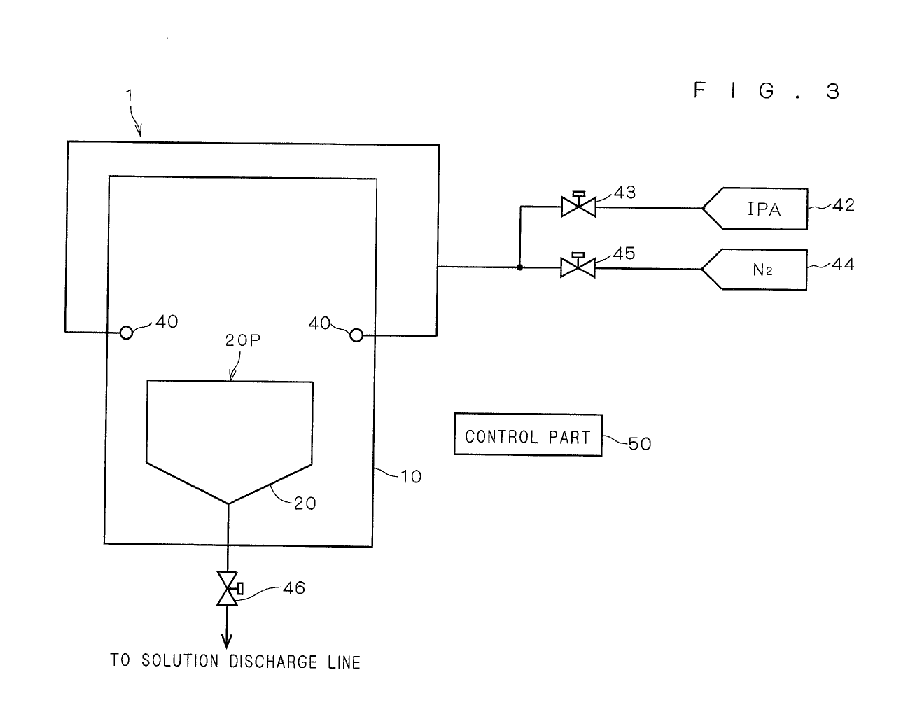

The processing bath 20, storing a chemical solution such as hydrofluoric acid or DI water (hereinafter generically referred to as “processing solution”) for successively surface-treating the substrates W, is contained in the chamber 10. A processing solution discharge nozzle (not shown) is arranged in the vicinity of the bottom of the processing bath 20, so that the processing solution can be supplied into the processing bath 20 from a processing solution source (not shown) through the processing solution discharge nozzle. This processing solution is supplied from the bottom of the processing bath 20 to overflow an overflow surface, i.e., an opening 20p of the processing bath 20. The processing bath 20 can also discharge the processing solution stored therein by opening a solution discharge valve 46 (see FIG. 3) described later.

The chamber 10 is a housing containing the processing bath 20, the hoisting mechanism 30, the supply nozzles 40 etc. therein. An upper portion 11 of the chamber 10 is openable/closable with a conceptually illustrated slide switching mechanism 12 (this slide switching mechanism 12 is not shown in FIGS. 2 to 9). When the upper portion 11 of the chamber 10 is open, the substrates W can be introduced/discharged from the open portion. When the upper portion 11 of the chamber 10 is closed, on the other hand, a sealed space can be defined in the chamber 10.

The hoisting mechanism 30 is employed for immersing a set (lot) of substrates W in the processing solution stored in the processing bath 20. The hoisting mechanism 30 comprises a lifter 31, a lifter arm 32 and three holding bars 33, 34 and 35 holding the substrates W. Each of the three holding bars 33, 34 and 35 is provided with a plurality of holding grooves arranged in an X direction at prescribed intervals for engaging with the outer edges of the substrates W and holding the same in an upright posture. These holding grooves are notched grooves. The three holding bars 33, 34 and 35 are fixed to the lifter arm 32, which in turn is movable along the vertical direction (Z direction) through the lifter 31.

According to this structure, the hoisting mechanism 30 can vertically move the plurality of substrates W arranged in parallel with each other along the X direction and collectively held by the three holding bars 33, 34 and 35 between a position (shown by solid lines in FIG. 1) immersed in the processing solution stored in the processing bath 20 and a position (shown by phantom lines in FIG. 1) pulled up from the processing solution. Any well-known mechanism such as a feed screw mechanism employing a ball screw or a belt mechanism employing a pulley and a belt can be employed for the lifter 31 as a mechanism for vertically moving the lifter arm 32. The substrates W can be transferred between a substrate transport robot (not shown) and the hoisting mechanism 30 by locating the hoisting mechanism 30 on a position shown by two-dot chain lines in FIG. 1 while opening the upper portion 11 of the chamber 10.

The two supply nozzles 40 are provided in the vicinity of the aforementioned overflow surface, i.e., in the vicinity of the opening 20p outside the processing bath 20. Each of the supply nozzles 40 serving as discharge parts is a hollow tubular member, extending along the X direction, comprising a plurality of discharge ports 41 arranged in the X direction at regular intervals. Each of the plurality of discharge ports 41 is formed to direct the discharge direction toward the opening 20p of the processing bath 20. Each supply nozzle 40 can discharge IPA vapor from the plurality of discharge ports 41 toward the opening 20p of the processing bath 20 for forming an atmosphere containing the IPA vapor in the processing bath 20.

Supply mechanisms provided outside the chamber 10 can supply IPA vapor and nitrogen gas employed as inert gas to the supply nozzles 40. FIG. 3 is a model diagram showing the structures of pipes etc. of the substrate processing apparatus 1. The supply nozzles 40 are connected to an IPA source 42 and a nitrogen gas source 44 through pipes. The IPA source 42 can supply IPA vapor to the supply nozzles 40 by opening an IPA valve 43. The IPA vapor supplied to the supply nozzles 40 is discharged from the plurality of discharge ports 41 toward the opening 20p of the processing bath 20 while forming flows parallel to the main surfaces of the substrates W. At this time, nitrogen gas is employed as carrier gas.

The nitrogen gas source 44 can supply nitrogen gas to the supply nozzles 40 by opening a nitrogen gas valve 45. The nitrogen gas supplied to the supply nozzles 40 is discharged from the discharge ports 41 toward the opening 20p of the processing bath 20 while forming flows parallel to the main surfaces of the substrates W.

In other words, the supply nozzles 40 can supply the IPA vapor to the opening 20p of the processing bath 20 when closing the nitrogen gas valve 45 and opening the IPA valve 43, and can supply the nitrogen gas to the opening 20p of the processing bath 20 when closing the IPA valve 43 and opening the nitrogen gas valve 45 to the contrary.

The bottom of the processing bath 20 is connected to a solution discharge line (not shown) through a pipe, and the solution discharge valve 46 is interposed in this pipe. When this solution discharge valve 46 is opened, it follows that the processing solution is discharged from the processing bath 20.

A control part 50 controls all of the operations of the IPA valve 43, the nitrogen gas valve 45 and the solution discharge valve 46 shown in FIG. 3. It follows that the control part 50 and the solution discharge valve 46 serve as discharge device.

<Drying in Substrate Processing Apparatus 1>

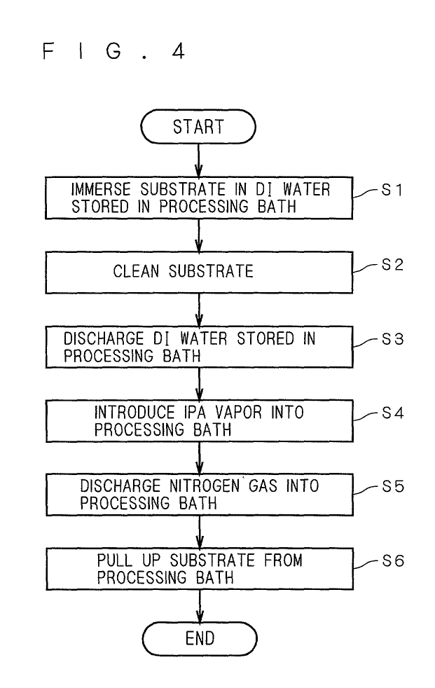

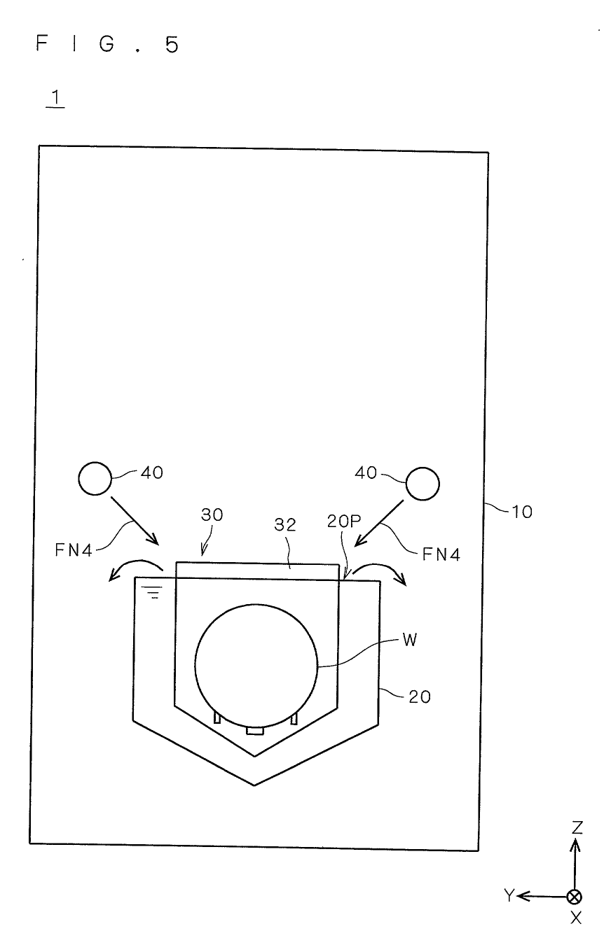

FIG. 4 is a flow chart illustrating the operation of substrate processing in the substrate processing apparatus 1. FIGS. 5 to 9 illustrate the way of the processing in the substrate processing apparatus 1. The procedure in the substrate processing apparatus 1 is now described with reference to FIGS. 4 to 9.

In order to process the substrates W in the substrate processing apparatus 1, the hoisting mechanism 30 first receives the plurality of substrates W from the substrate transport robot (not shown). The chamber 10 is sealed, while the hoisting mechanism 30 downwardly moves the plurality of substrates W collectively held at intervals from each other along the X direction, for immersing the same in DI water stored in the processing bath 20 through the opening 20p for introducing the substrates W into the processing bath 20 (step S1). In this stage, the processing bath 20 is continuously supplied with DI water, which in turn continuously overflows the overflow surface on the upper end of the processing bath 20. The DI water overflowing the processing bath 20 is collected by a collection part provided outside the upper end of the processing bath 20, to be discharged to the solution discharge line (not shown).

At a step S2, the substrate processing apparatus 1 cleans the substrates W.

The substrate processing apparatus 1 successively supplies a chemical solution or DI water into the processing bath 20 while keeping the state immersing the plurality of substrates W in the DI water stored in the processing bath 20, thereby progressing etching and cleaning along predetermined order (see FIG. 5). Also in this stage, the chemical solution or DI water continuously overflows the upper end of the processing bath 20, and the overflowing processing solution is collected by the aforementioned collection part.

In the state shown in FIG. 5, the supply nozzles 40 discharge the nitrogen gas toward the opening 20p of the processing bath 20, as shown by arrows FN4 in FIG. 5. Thus, it follows that a nitrogen atmosphere is formed in the chamber 10 for processing the substrates W under the nitrogen atmosphere.

Progress of surface treatment of the substrates W finally reaches finish cleaning. According to this embodiment, the substrate processing apparatus 1 performs the finish cleaning also by storing DI water in the processing bath 20 and immersing the plurality of substrates W in the DI water, similarly to general cleaning. The nitrogen gas is supplied also in the final stage of the finish cleaning, so that the supply nozzles 40 discharge the nitrogen gas for performing the finish cleaning under a nitrogen atmosphere.

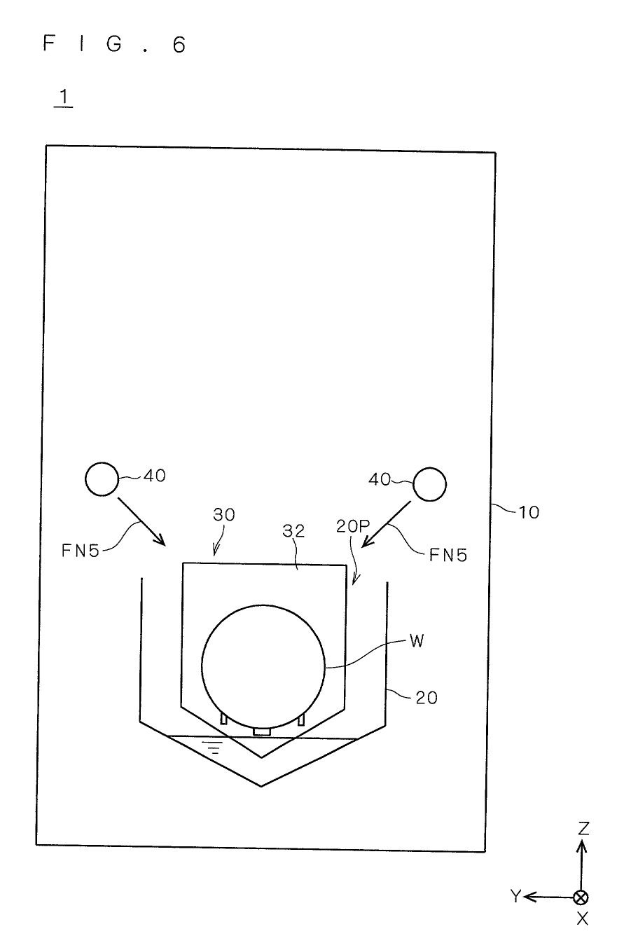

At a step S3, the DI water stored in the processing bath 20 is discharged. When the substrates W are completely cleaned (step S2) in the processing bath 20, the DI water stored in the processing bath 20 is discharged while holding the substrates W in the processing bath 20 as shown in FIG. 6. Also at this time, the supply nozzles 40 discharge the nitrogen gas toward the substrates W as shown by arrows FN5 in FIG. 6, for introducing the nitrogen gas into the processing bath 20. Thus, it follows that the overall surfaces of the substrates W are covered with nitrogen.

When the DI water is discharged while holding the substrates W in the processing bath 20 as described above, i.e., when the phase boundary (water surface) in the processing bath 20 is lowered for exposing the substrates W to the atmosphere in the chamber 10, the substrates W are not swung (vibrated) dissimilarly to a case of pulling up the substrates W from the DI water thereby exposing the same. Thus, it is possible to effectively prevent particles from re-adhering to the substrates W in the vicinity of the phase boundary. In particular, the method discharging the DI water while holding the substrates W is effective for increasing the speed for exposing the substrates W to the atmosphere.

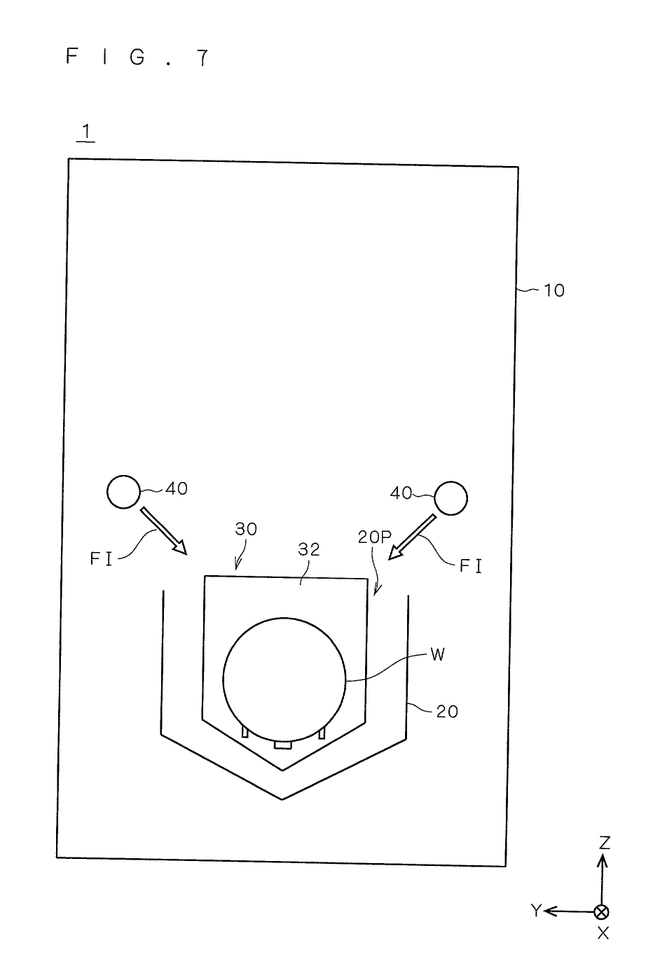

At a step S4, IPA vapor (containing nitrogen gas serving as carrier gas) is introduced into the processing bath 20. After the DI water is completely discharged from the processing bath 20 (step S3), the substrates W are not pulled up but the supply nozzles 40 introduce the IPA vapor into the processing bath 20 as shown by arrows FI in FIG. 7 while the hoisting mechanism 30 serving as holding device holds the plurality of substrates W in the processing bath 20 as shown in FIG. 7. In other words, it follows that the substrates W having been exposed to the nitrogen gas in the processing bath 20 are dried with the IPA vapor. Thus, it follows that not a gas mixture but single gas, i.e., only IPA acts on the substrates W to cover the overall surfaces thereof.

The IPA vapor may sufficiently be supplied into the processing bath 20 having a smaller volume than the chamber 10 due to the operation at the step S4, whereby consumption of IPA gas can be reduced. Assuming that Va and Vb represent the volumes of the chamber 10 and the processing bath 20 respectively, for example, it follows that consumption of IPA can be reduced to about Va/Vb in principle as compared with a conventional method filling up the overall chamber 10 with the IPA vapor.

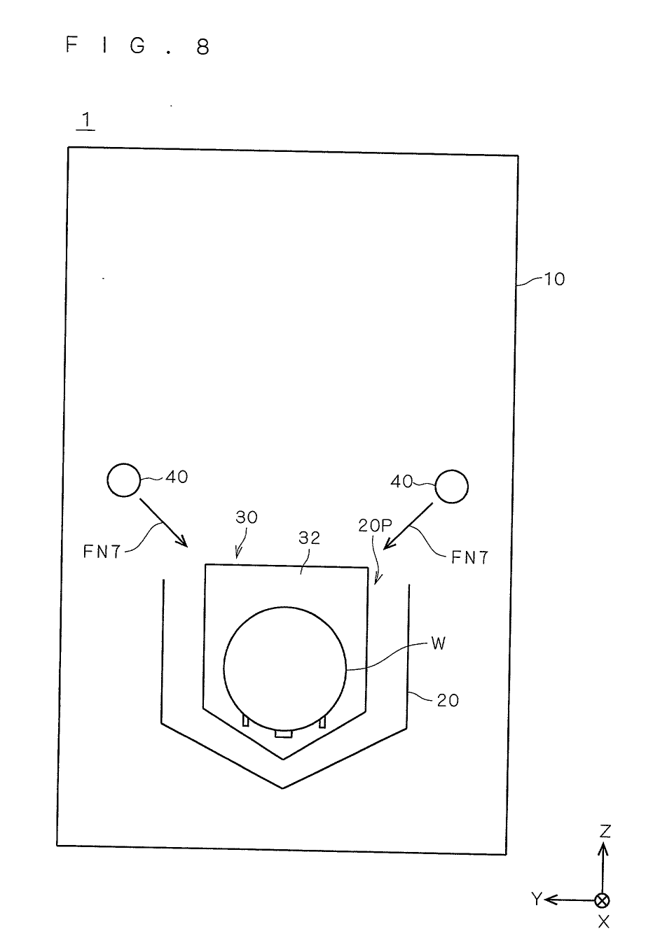

At a step S5, the supply nozzles 40 discharge the nitrogen gas into the processing bath 20 along arrows FN7 in FIG. 8 while holding the substrates W in the processing bath 20 as shown in FIG. 8. It follows that the substrates W are completely dried in the processing bath 20 and the IPA vapor is discharged from the chamber 10 due to this supply of the nitrogen gas. The IPA vapor is discharged from the chamber 10 through a discharge pipe (not shown) provided on the chamber 10.

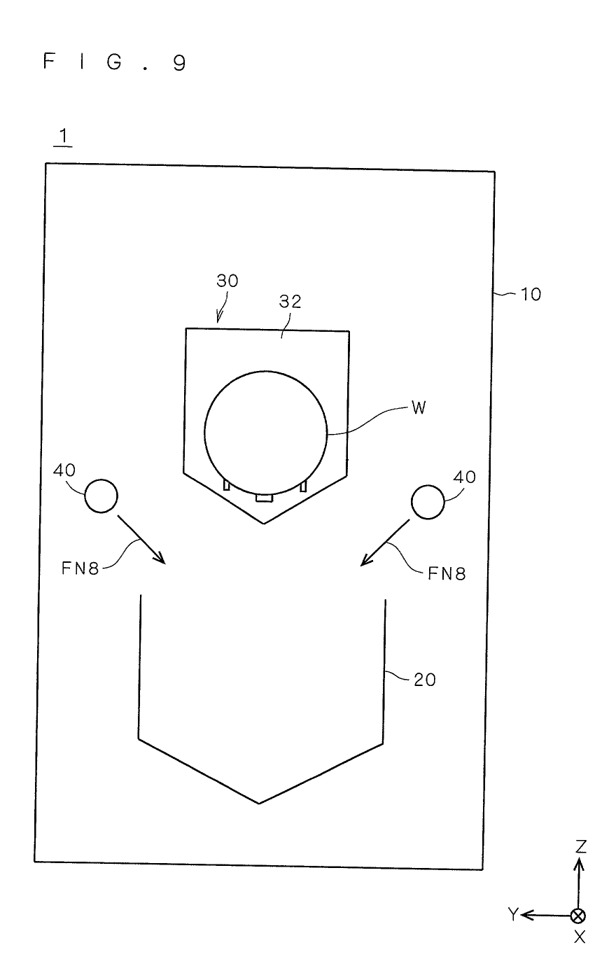

At a step S6, the substrates W are pulled up from the processing bath 20. At this time, a nitrogen gas atmosphere is formed in the chamber 10, and the hoisting mechanism 30 pulls up the plurality of substrates W while the supply nozzles 40 discharge nitrogen gas flows FN8 as shown in FIG. 9.

When the substrates W thereafter reach the position shown by phantom lines in FIG. 1, the hoisting mechanism 30 is stopped to complete the operation of pulling up the substrates W. At this point of time, the supply nozzles 40 stop supplying the nitrogen gas. The substrates W pulled up to the position shown by phantom lines in FIG. 1 are transferred to the substrate transport robot and the series of processing is completed.

The IPA vapor is introduced while holding the substrates W in the processing bath 20 due to the aforementioned operation of the substrate processing apparatus 1, whereby the quantity of the supplied IPA vapor can be reduced while drying efficiency is improved.

The IPA vapor and the nitrogen gas, which are discharged from the same supply nozzles 40 in the aforementioned first embodiment, may alternatively be discharged from different nozzles respectively.

While the first embodiment has been described with reference to the IPA vapor employed as the vapor of an organic solvent, vapor of another organic solvent such as low-molecular alcohol, silicone or hydrofluoroether (HFE) can alternatively be employed.

<Second Embodiment>

<Structure of Principal Part of Substrate Processing Apparatus>

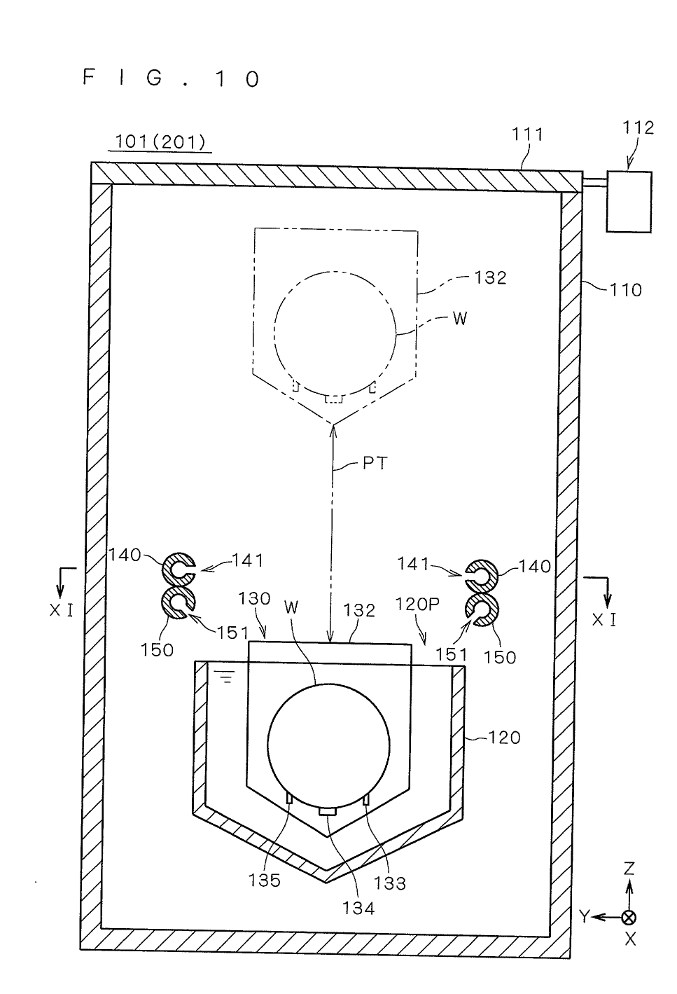

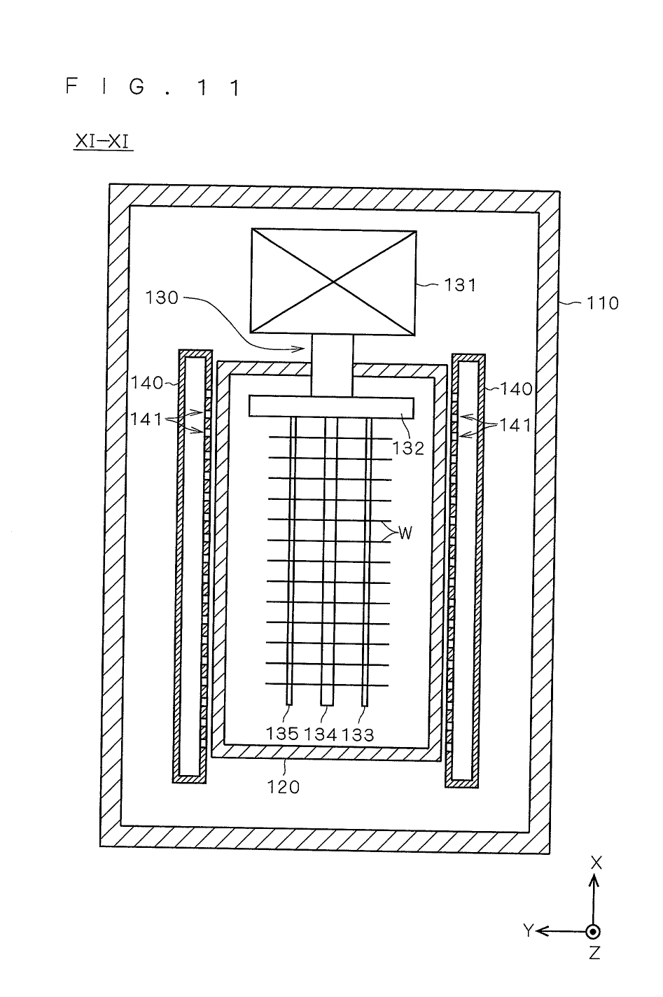

FIG. 10 is a front elevational view of a substrate processing apparatus 101 according to a second embodiment of the present invention. FIG. 11 is a sectional view taken along the line XI-XI in FIG. 10. An XYZ Cartesian coordinate system having an X-Y horizontal plane and a Z-axis vertical direction is properly assigned to each of FIG. 10 and subsequent drawings, in order to clarify the directional relation.

The substrate processing apparatus 101, drying substrates W completely cleaned with DI water with IPA employed as an organic solvent, mainly comprises a chamber 110, a processing bath 120, a hoisting mechanism 130, first supply nozzles 140 and second supply nozzles 150.

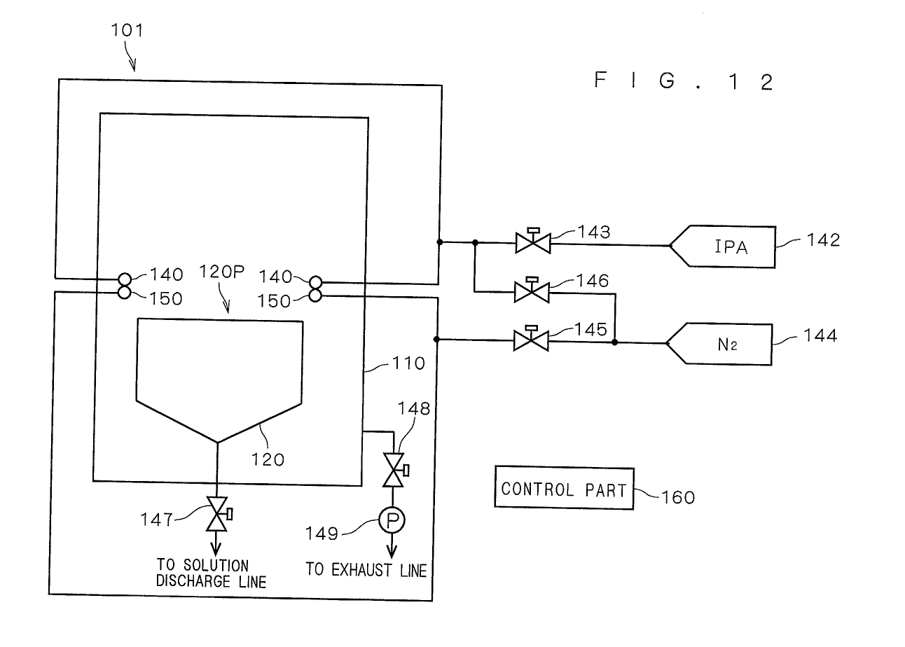

The processing bath 120, storing a chemical solution such as hydrofluoric acid or DI water (hereinafter generically referred to as “processing solution”) for successively surface-treating the substrates W, is stored in the chamber 110. A processing solution discharge nozzle (not shown) is arranged in the vicinity of the bottom of the processing bath 120, so that the processing solution can be supplied into the processing bath 120 from a processing solution source (not shown) through the processing solution discharge nozzle. This processing solution is supplied from the bottom of the processing bath 120 to overflow an overflow surface, i.e., an opening 120p of the processing bath 120. The processing bath 120 can also discharge the processing solution stored therein by opening a solution discharge valve 147 (see FIG. 12) described later.

The chamber 110 is a housing containing the processing bath 120, the hoisting mechanism 130, the first supply nozzles 140, the second supply nozzles 150 etc. therein. An upper portion 111 of the chamber 110 is openable/closable by a conceptually illustrated slide switching mechanism 112 (this slide switching mechanism 112 is not shown in FIGS. 11 to 17). When the upper portion 111 of the chamber 110 is open, the substrates W can be introduced/discharged from the open portion. When the upper portion 111 of the chamber 110 is closed, on the other hand, a sealed space can be defined in the chamber 110.

The hoisting mechanism 130 is employed for immersing a set (lot) of substrates W in the processing solution stored in the processing bath 120, to function as holding device and pull-up device. This hoisting mechanism 130 comprises a lifter 131, a lifter arm 132 and three holding bars 133, 134 and 135 holding the substrates W. Each of the three holding bars 133, 134 and 135 is provided with a plurality of holding grooves arranged in an X direction at prescribed intervals for engaging with the outer edges of the substrates W and holding the same in an upright posture. These holding grooves are notched grooves. The three holding bars 133, 134 and 135 are fixed to the lifter arm 132, which in turn is movable along the vertical direction (Z direction) through the lifter 131.

According to this structure, the hoisting mechanism 130 can vertically move the plurality of substrates W arranged in parallel with each other along the X direction and held by the three holding bars 133, 134 and 135 between a position (shown by solid lines in FIG. 10) immersed in the processing solution stored in the processing bath 120 and a position (shown by phantom lines in FIG. 10) pulled up from the processing solution. Any well-known mechanism such as a feed screw mechanism employing a ball screw or a belt mechanism employing a pulley and a belt can be employed for the lifter 131 as a mechanism for vertically moving the lifter arm 132. The substrates W can be transferred between a substrate transport robot (not shown) and the hoisting mechanism 130 by locating the hoisting mechanism 130 on a position shown by two-dot chain lines in FIG. 10 and opening the upper portion 111 of the chamber 110.

The two first supply nozzles 140 are provided in the vicinity of the opening 120p outside the processing bath 120. These two first supply nozzles 140 are provided on both sides of the plurality of substrates W pulled up by the hoisting mechanism 130 respectively. Each of the first supply nozzles 140 is a hollow tubular member, extending along the X direction, comprising a plurality of discharge ports 141 arranged in the X direction at regular intervals. Each of the plurality of discharge ports 141 is formed to direct the discharge direction in parallel with the overflow surface. Each first supply nozzle 140 can discharge IPA vapor or nitrogen gas serving as inert gas from the plurality of discharge ports 141 in the horizontal direction (Y direction) for forming an atmosphere of the IPA vapor or the nitrogen gas above the processing bath 120.

The two second supply nozzles 150 serving as discharge parts are provided in the vicinity of the opening 120p of the processing bath 120, more specifically outward and upward beyond the upper end of the processing bath 120 in the chamber 110. These two second supply nozzles 150 are provided under the first supply nozzles 140 respectively. Each of the second supply nozzles 150 is a hollow tubular member, extending along the X direction, comprising a plurality of discharge ports 151 arranged in the X direction at regular intervals. Each of the plurality of discharge ports 151 is formed to direct the discharge direction toward the opening 120p of the processing bath 120. Each second supply nozzle 150 can discharge nitrogen gas from the plurality of discharge ports 151 toward the opening 120p of the processing bath 120 for forming an atmosphere containing the nitrogen gas in the processing bath 120.

Supply mechanisms provided outside the chamber 110 can supply IPA vapor and nitrogen gas to the first and second supply nozzles 140 and 150 respectively. FIG. 12 is a model diagram showing the structures of pipes etc. of the substrate processing apparatus 101. The first supply nozzles 140 are connected to an IPA source 142 and a nitrogen gas source 144 through pipes. The IPA source 142 can supply IPA vapor to the first supply nozzles 140 by opening an IPA valve 143. The IPA vapor supplied to the first supply nozzles 140 is horizontally discharged from the plurality of discharge ports 141 while forming flows parallel to the main surfaces of the substrates W. At this time, nitrogen gas is employed as carrier gas.

The nitrogen gas source 144 can supply nitrogen gas to the first supply nozzles 140 by opening a nitrogen gas valve 146. The nitrogen gas supplied to the first supply nozzles 140 is horizontally discharged from the plurality of discharge ports 141 while forming flows parallel to the main surfaces of the substrates W.

In other words, the first supply nozzles 140 can supply the IPA vapor in parallel with the overflow surface of the processing bath 120 when closing the nitrogen gas valve 146 and opening the IPA valve 143, and can supply the nitrogen gas in parallel with the overflow surface of the processing bath 120 when closing the IPA valve 143 and opening the nitrogen gas valve 146 to the contrary.

The second supply nozzles 150 are connected to the nitrogen gas source 144 through a pipe. The nitrogen gas source 144 can supply the nitrogen gas to the second supply nozzles 150 by opening a nitrogen gas valve 145. The nitrogen gas supplied to the second supply nozzles 150 is horizontally discharged from the plurality of discharge ports 151 toward the opening 120p of the processing bath 120 while forming flows parallel to the main surfaces of the substrates W.

The bottom of the processing bath 120 is connected to a solution discharge line (not shown) through a pipe, and the solution discharge valve 147 is interposed in this pipe. When the solution discharge valve 147 is opened, it follows that the processing solution is discharged from the processing bath 120.

The chamber 110 is connected with an exhaust line (not shown) through a pipe, and an exhaust valve 148 and an exhaust (decompression) pump 149 are interposed in this pipe. When the exhaust valve 148 is opened while driving the exhaust pump 149, it follows that the processing solution is discharged from the chamber 110.

A control part 160 controls all of the operations of the IPA valve 143, the nitrogen gas valves 145 and 146, the solution discharge valve 147, the exhaust valve 148 and the exhaust pump 149 shown in FIG. 12. It follows that the control part 160 and the solution discharge valve 147 serve as discharge device.

<Drying in Substrate Processing Apparatus 101>

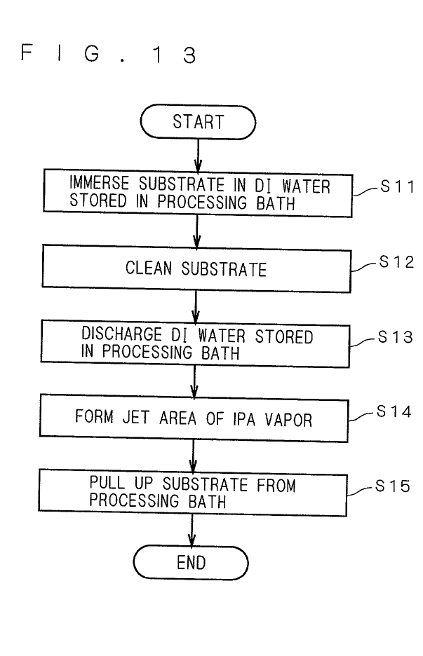

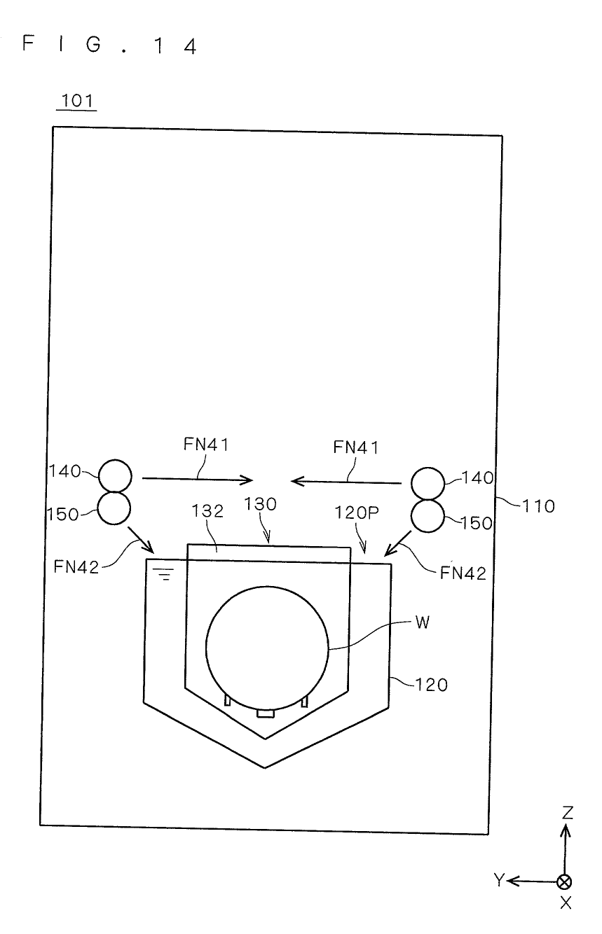

FIG. 13 is a flow chart illustrating the operation of substrate processing in the substrate processing apparatus 101. FIGS. 14 to 17 illustrate the way of the processing in the substrate processing apparatus 101. The procedure in the substrate processing apparatus 101 is now described with reference to FIGS. 13 to 17.

In order to process the substrates W in the substrate processing apparatus 101, the hoisting mechanism 130 first receives the plurality of substrates W from the substrate transport robot (not shown). The chamber 110 is sealed, while the hoisting mechanism 130 downwardly moves the plurality of substrates W collectively held at intervals from each other along the X direction, for immersing the same in DI water stored in the processing bath 120 through the opening 120p for introducing the substrates W into the processing bath 120 (step S11). In this stage, the processing bath 120 is continuously supplied with DI water, which in turn continuously overflows the overflow surface on the upper end of the processing bath 120. The DI water overflowing the processing bath 120 is collected by a collection part provided outside the upper end of the processing bath 120, to be discharged to the solution discharge line (not shown).

At a step S12, the substrate processing apparatus 101 cleans the substrates W. The substrate processing apparatus 101 successively supplies a chemical solution or DI water into the processing bath 120 while keeping the state immersing the plurality of substrates W in the DI water stored in the processing bath 120, thereby progressing etching and cleaning along predetermined order (see FIG. 14). Also in this stage, the chemical solution or DI water continuously overflows the upper end of the processing bath 120, and the overflowing processing solution is collected by the aforementioned collection part.

In the state shown in FIG. 14, the first supply nozzles 140 horizontally discharge the nitrogen gas as shown by arrows FN41 in FIG. 14, while the second supply nozzles 150 discharge the nitrogen gas toward the opening 120p of the processing bath 120 as shown by arrows FN42 in FIG. 14. Thus, it follows that a nitrogen atmosphere is formed in the chamber 110 for processing the substrates W under the nitrogen atmosphere.

Progress of surface treatment of the substrates W finally reaches finish cleaning. According to this embodiment, the substrate processing apparatus 101 performs the finish cleaning also by storing DI water in the processing bath 120 and immersing the plurality of substrates W in the DI water, similarly to general cleaning. The nitrogen gas is supplied also in the stage of the final finish cleaning, so that the first and second supply nozzles 140 and 150 discharge the nitrogen gas for performing the finish cleaning under a nitrogen atmosphere.

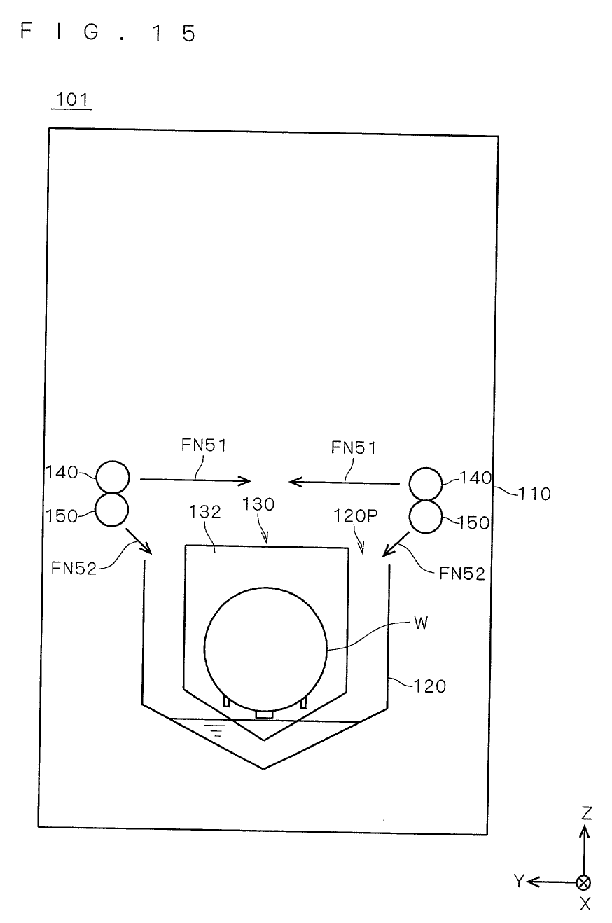

At a step S13, the DI water stored in the processing bath 120 is discharged. When the substrates W are completely cleaned (step S12) in the processing bath 120, the DI water stored in the processing bath 120 is discharged while holding the substrates W in the processing bath 120 as shown in FIG. 15. Also at this time, the first supply nozzles 140 horizontally discharge the nitrogen gas as shown by arrows FN51 in FIG. 15 while the second supply nozzles 150 supply the nitrogen gas toward the opening 120p of the processing bath 120 as shown by arrows FN52 in FIG. 15, for introducing the nitrogen gas into the processing bath 120. Thus, it follows that the substrates W can be prevented from formation of watermarks. Further, the overall surfaces of the substrates W are covered with nitrogen due to the nitrogen gas introduced into the processing bath 120.

When the DI water is discharged while holding the substrates W in the processing bath 120 as described above, i.e., when the phase boundary (water surface) in the processing bath 120 is lowered for exposing the substrates W to the atmosphere in the chamber 110, the substrates W are not swung (vibrated) dissimilarly to a case of pulling up the substrates W from the DI water thereby exposing the same. Thus, it is possible to effectively prevent particles from re-adhering to the substrates W in the vicinity of the phase boundary. In particular, the method discharging the DI water while holding the substrates W is effective for increasing the speed for exposing the substrates W to the atmosphere.

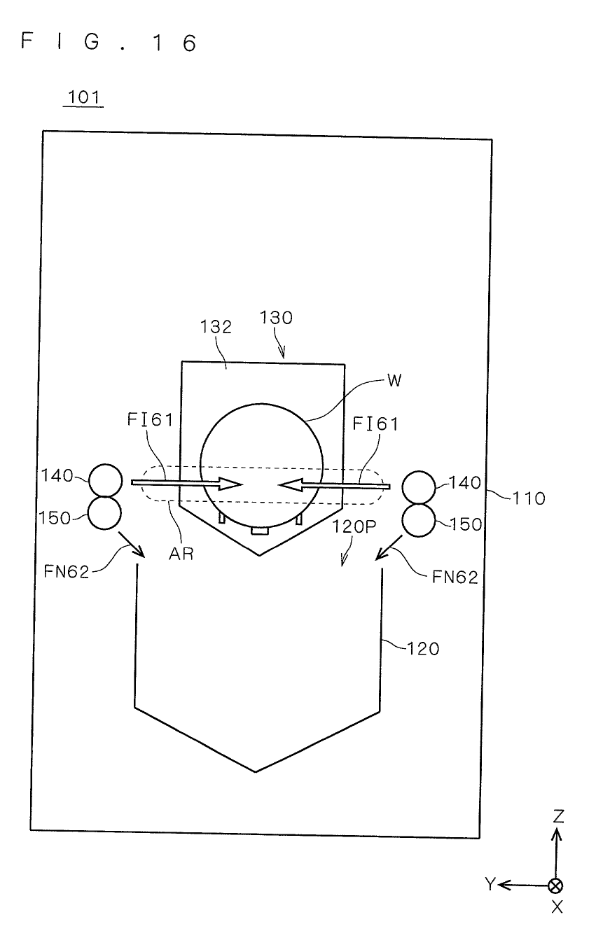

At a step S14, a jet area AR of the IPA vapor is formed. After the DI water is completely discharged from the processing bath 120 (step S13), the first supply nozzles 140 serving as discharge parts substantially horizontally discharge IPA vapor FI61 above the processing bath 120, to form the jet area AR of the IPA vapor as shown by phantom lines in FIG. 16. This jet area AR of the IPA vapor defines a zone of the IPA vapor having at least a constant flow velocity in the discharge direction of the discharge ports 141 around the first supply nozzles 140. The second supply nozzles 150 continuously supply nitrogen gas flows FN62 into the processing bath 120.

At a step S15, the substrates W are pulled up from the processing bath 120. At this time, the hoisting mechanism 130 serving as pull-up device is driven for collectively pulling up the plurality of substrates W separated from each other from the processing bath 120. As shown in FIG. 16, the plurality of substrates W pass through the jet area AR locally formed in the chamber 110 by the first supply nozzles 140, as shown in FIG. 16. It follows that IPA vapor is directly sprayed toward the substrates W in the jet area AR of the IPA vapor formed in part of a pull-up passage PT (see FIG. 10), for drying the plurality of substrates W. In this case, it follows that not a gas mixture but single gas, i.e., only IPA acts on the substrates W having been exposed to the nitrogen gas, for covering the overall surfaces of the substrates W.

Thus, the IPA vapor can be efficiently supplied to the substrates W passing through the jet area AR, whereby consumption of the IPA vapor can be reduced. In other words, the IPA vapor is so intensively supplied to a partial space in the chamber 110 that it follows that consumption of IPA can be remarkably reduced as compared with the conventional method supplying IPA vapor into the overall chamber 110.

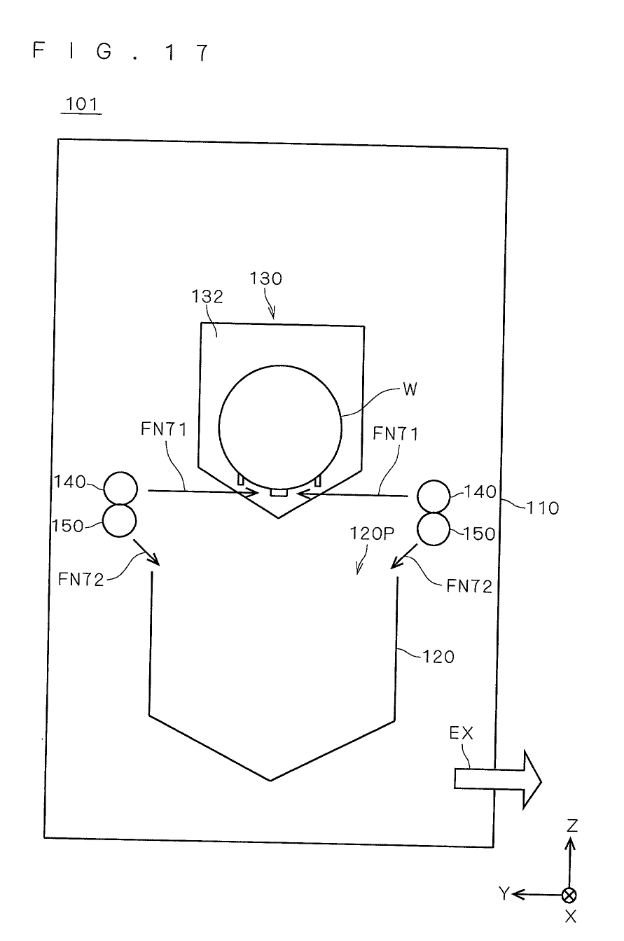

When the substrates W pass through the jet area AR of the IPA vapor, the first supply nozzles 140 horizontally discharge nitrogen gas as shown by arrows FN71 in FIG. 17. The second supply nozzles 150 supply nitrogen gas flows FN72 into the processing bath 120. The exhaust pump 149 is driven while the first and second supply nozzles 140 and 150 supply nitrogen gas into the chamber 110, for discharging the IPA vapor from the chamber 110 as shown by arrow EX in FIG. 17. Thus, the substrates W are so completely dried that it follows that the remaining part of the IPA vapor employed for drying the substrates W can be reduced in concentration and removed from the chamber 110.

When the substrates W further pulled up by the hoisting mechanism 130 thereafter reach the position shown by phantom lines in FIG. 10, the hoisting mechanism 130 is stopped to complete the operation of pulling up the substrates W. At this point of time, the first and second supply nozzles 140 and 150 stop supplying the nitrogen gas. The substrates W pulled up to the position shown by phantom lines in FIG. 10 are transferred to the substrate transport robot and the series of processing is completed.

The substrates W are pulled up to pass through the jet area AR of the IPA vapor which in turn is directly supplied to the substrates W due to the aforementioned operation of the substrate processing apparatus 101, whereby the quantity of supplied IPA can be reduced while improving drying efficiency. The substrates W passing through the jet area AR of the IPA vapor can be more homogeneously dried.

The substrate processing apparatus 101 according to the aforementioned second embodiment may alternatively supply heated nitrogen gas.

<Third Embodiment>

<Structure of Principal Part of Substrate Processing Apparatus>

A substrate processing apparatus 201 according to a third embodiment of the present invention is similar in structure to the substrate processing apparatus 101 according to the second embodiment shown in FIGS. 10 and 11.

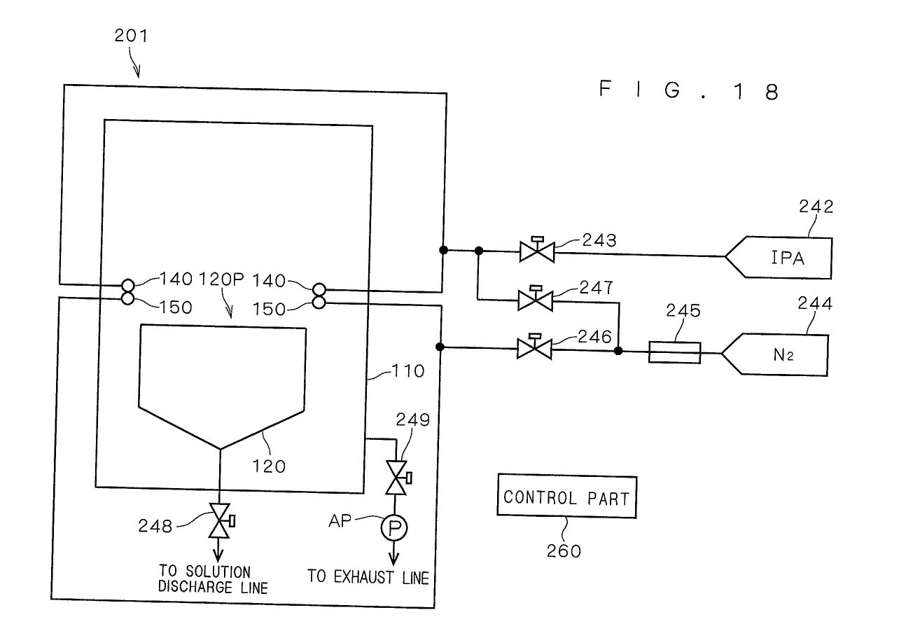

FIG. 18 is a model diagram showing the structures of pipes etc. of the substrate processing apparatus 201. First supply nozzles 140 are connected to an IPA source 242 and a nitrogen gas source 244 through pipes. The IPA source 242 can supply low-concentration IPA vapor to the first supply nozzles 140 by opening an IPA valve 243. The low-concentration IPA vapor supplied to the first supply nozzles 140 is horizontally discharged from a plurality of discharge ports 141 while forming flows parallel to the main surfaces of substrates W. At this time, nitrogen gas is employed as carrier gas.

The nitrogen gas source 244 can supply nitrogen gas to the first supply nozzles 140 by opening a nitrogen gas valve 247. The nitrogen gas supplied to the first supply nozzles 140 is horizontally discharged from the plurality of discharge ports 141.

A heater 245 is provided on an intermediate portion of the passage of the pipe guided from the nitrogen gas source 244. The nitrogen gas supplied from the nitrogen gas source 244 to the first supply nozzles 140 can be heated to a higher temperature than DI water stored in a processing bath 120 by driving the heater 245. Thus, the plurality of discharge ports 141 of the first supply nozzles 140 can horizontally discharge high-temperature nitrogen gas while forming flows parallel to the main surfaces of the substrates W.

In other words, it follows that the first supply nozzles 140 can supply the low-concentration IPA vapor in parallel with an overflow surface of the processing bath 120 when closing the nitrogen gas valve 247 and opening the IPA valve 243, and can supply high-temperature nitrogen gas in parallel with the overflow surface of the processing bath 120 when closing the IPA valve 243 and opening the nitrogen gas valve 247 to the contrary.

Second supply nozzles 150 are connected to the nitrogen gas source 244 through a pipe. The nitrogen gas source 244 can supply nitrogen gas to the second supply nozzles 150 by opening a nitrogen gas valve 246. The nitrogen gas supplied to the second supply nozzles 150 is horizontally discharged from a plurality of discharge ports 151 toward an opening 120p of the processing bath 120 while forming flows parallel to the main surfaces of the substrates W. It follows that high-temperature nitrogen gas can be supplied into the processing bath 120 by driving the heater 245 serving as heating device.

The bottom of the processing bath 120 is connected to a solution discharge line (not shown) through a pipe, and a solution discharge valve 248 is interposed in this pipe. When the solution discharge valve 248 is opened, it follows that a processing solution is discharged from the processing bath 120.

A chamber 110 is connected with an exhaust line (not shown) through a pipe, and an exhaust valve 249 and an exhaust (decompression) pump AP are interposed in this pipe. When the exhaust valve 249 is opened while driving the exhaust pump AP, it follows that the chamber 110 is evacuated.

A control part 260 controls all of the operations of the IPA valve 243, the nitrogen gas valves 246 and 247, the heater 245, the solution discharge valve 248, the exhaust valve 249 and the exhaust pump AP shown in FIG. 18. It follows that the control part 260 and the solution discharge valve 248 serve as discharge device.

<Drying in Substrate Processing Apparatus 201>

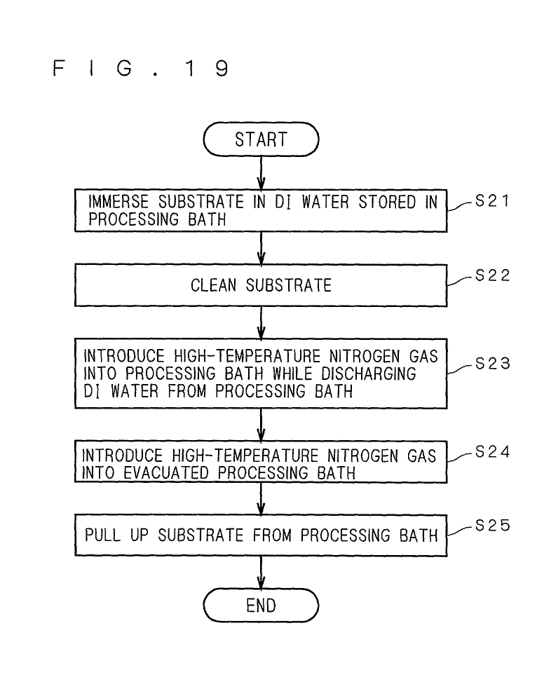

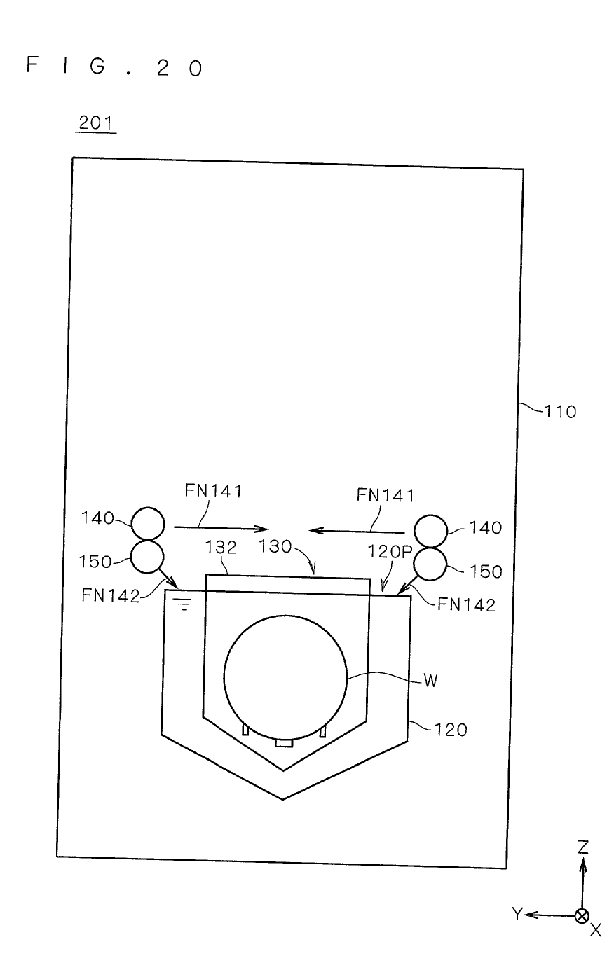

FIG. 19 is a flow chart illustrating the operation of substrate processing in the substrate processing apparatus 201. FIGS. 20 to 23 illustrate the way of the processing in the substrate processing apparatus 201. The procedure in the substrate processing apparatus 201 is now described with reference to FIGS. 19 to 23.

In order to process the substrates W in the substrate processing apparatus 201, a hoisting mechanism 130 first receives the plurality of substrates W from a substrate transport robot (not shown). The chamber 110 is sealed, while the hoisting mechanism 130 downwardly moves the plurality of substrates W collectively held at intervals from each other along the X direction, for immersing the same in DI water stored in the processing bath 120 through the opening 120p for introducing the substrates W into the processing bath 120 (step S21). In this stage, the processing bath 120 is continuously supplied with DI water, which in turn continuously overflows the overflow surface on the upper end of the processing bath 120. The DI water overflowing the processing bath 120 is collected by a collection part provided outside the upper end of the processing bath 120, to be discharged to the solution discharge line (not shown).

At a step S22, the substrate processing apparatus 201 cleans the substrates W. The substrate processing apparatus 201 successively supplies a chemical solution or DI water into the processing bath 120 while keeping the state immersing the plurality of substrates W in the DI water stored in the processing bath 120, thereby progressing etching and cleaning along predetermined order (see FIG. 20). Also in this stage, the chemical solution or DI water continuously overflows the upper end of the processing bath 120, and the overflowing processing solution is collected by the aforementioned collection part.

In the state shown in FIG. 20, the first supply nozzles 140 horizontally discharge high-temperature nitrogen gas as shown by arrows FN141 in FIG. 20, while the second supply nozzles 150 discharge high-temperature nitrogen gas toward the opening 120p of the processing bath 120 as shown by arrows FN142 in FIG. 20. Thus, it follows that a nitrogen atmosphere is formed in the chamber 110 for processing the substrates W under the nitrogen atmosphere.

Progress of surface treatment of the substrates W finally reaches finish cleaning. According to this embodiment, the substrate processing apparatus 201 performs the finish cleaning also by storing DI water in the processing bath 120 and immersing the plurality of substrates W in the DI water, similarly to general cleaning. The high-temperature nitrogen gas is supplied also in the stage of the final finish cleaning, so that the first and second supply nozzles 140 and 150 discharge the high-temperature nitrogen gas for performing finish cleaning under a nitrogen atmosphere.

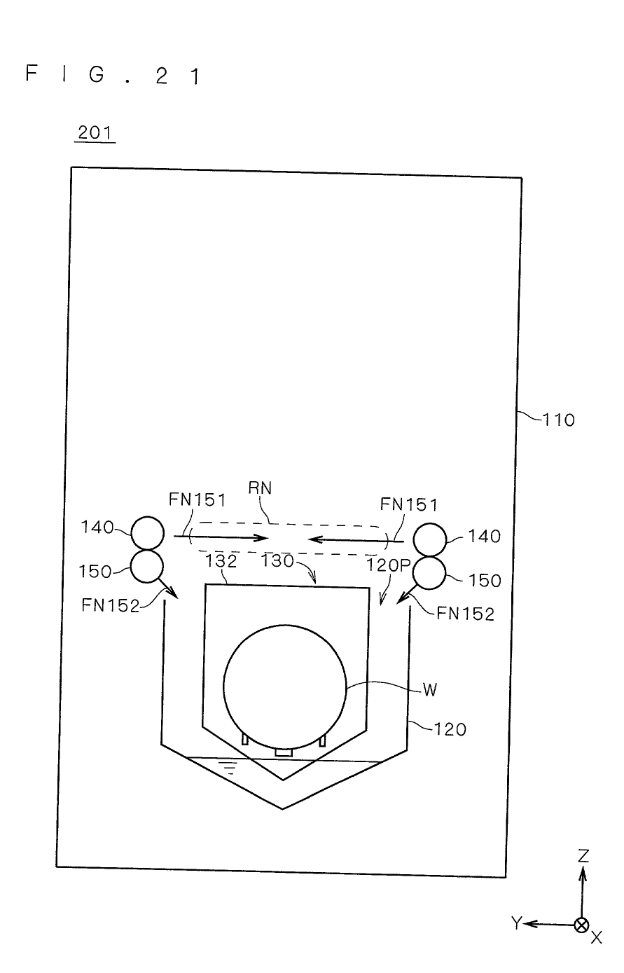

At a step S23, the DI water stored in the processing bath 120 is discharged, while high-temperature nitrogen gas is introduced into the processing bath 120. When the substrates W are completely cleaned (step S22) in the processing bath 120, the DI water stored in the processing bath 120 is discharged while holding the substrates W in the processing bath 120 as shown in FIG. 21. At this time, the second supply nozzles 150 supply high-temperature nitrogen gas toward the opening 120p of the processing bath 120 as shown by arrows FN152 in FIG. 21 while increasing the feed rate beyond that in FIG. 20, for introducing the high-temperature nitrogen gas into the processing bath 120. Thus, the substrate processing apparatus 201 starts processing for drying the substrates W. The overall surfaces of the substrates W are covered with nitrogen due to the nitrogen gas introduced into the processing bath 120.

When the DI water is discharged while holding the substrates W in the processing bath 120 as described above, i.e., when the phase boundary (water surface) in the processing bath 120 is lowered for exposing the substrates W to the atmosphere in the chamber 110, the substrates W are not swung (vibrated) dissimilarly to a case of pulling up the substrates W from the DI water thereby exposing the same. Thus, it is possible to effectively prevent particles from re-adhering to the substrates W in the vicinity of the phase boundary. In particular, the method discharging the DI water while holding the substrates W is effective for increasing the speed for exposing the substrates W to the atmosphere.

The first supply nozzles 140 substantially horizontally discharge high-temperature nitrogen gas as shown by arrows FN151 in FIG. 21, for forming a jet area RN of the nitrogen gas covering the opening 120p of the processing bath 20. It follows that this jet area RN of the nitrogen gas serves as an air curtain sealing the processing bath 120 with the high-temperature nitrogen gas supplied from the second supply nozzles 150 and suppressing heat exchange between the interior and the exterior of the processing bath 120. Thus, the substrate processing apparatus 201 can properly dry the substrates W with the high-temperature nitrogen gas flowing into the processing bath 120.

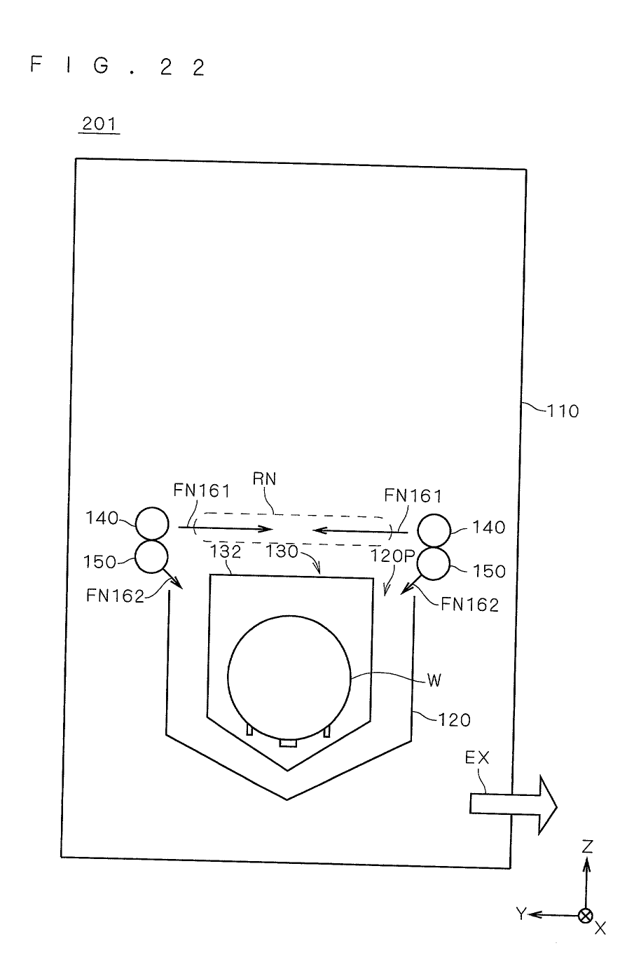

At a step S24, high-temperature nitrogen gas is introduced into the evacuated processing bath 120. Also after the DI water is discharged from the processing bath 120, the first supply nozzles 140 continuously discharge high-temperature nitrogen gas flows FN161 for forming the jet area RN of the nitrogen gas covering the opening 120p of the processing bath 120 while the second supply nozzles 150 discharge high-temperature nitrogen gas flows FN162 and introduce the same into the processing bath 120 as shown in FIG. 22. Thus, the high-temperature nitrogen gas flows into the processing bath 120 having a smaller volume than the chamber 110, whereby it follows that consumption of the high-temperature nitrogen gas employed for drying the substrates W can be reduced and the substrates W can be quickly dried. At this time, the exhaust pump AP is driven for discharging the atmosphere from the chamber 110 as shown by arrow EX in FIG. 22 and decompressing the chamber 110, in order to improve drying conditions.

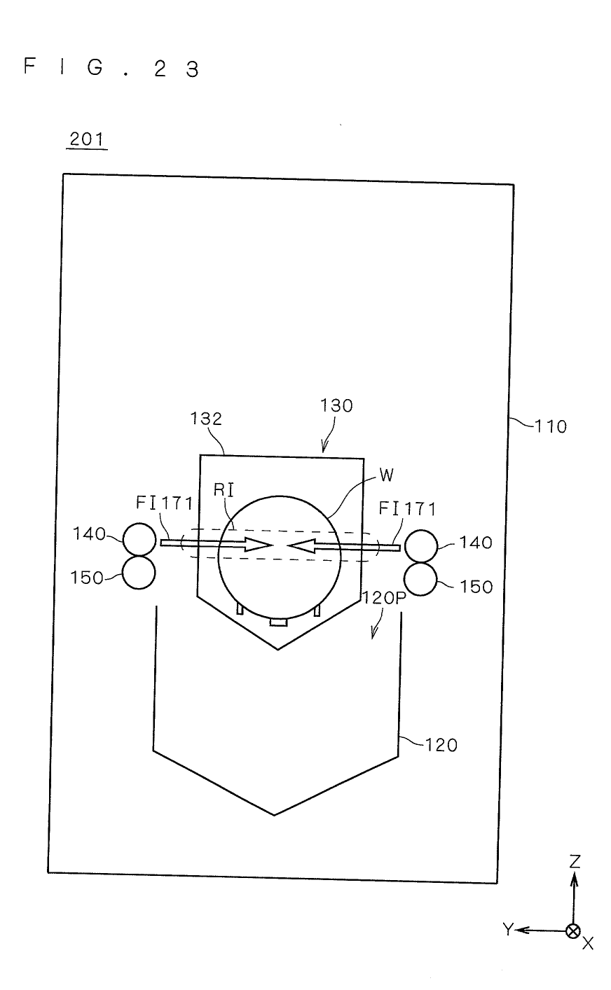

At a step S25, the substrates W are pulled up from the processing bath 120. At this time, the hoisting mechanism 130 is driven for pulling up the plurality of substrates W from the processing bath 120. The first and second supply nozzles 140 and 150 stop discharging the high-temperature nitrogen gas while the first supply nozzles 140 discharge low-concentration IPA vapor FI171 for substantially horizontally forming a jet area RI of the IPA vapor above the opening 120p of the processing bath 120 as shown in FIG. 23. The substrates W are pulled up to pass through the jet area RI of the IPA vapor.

Thus, the low-concentration IPA vapor is directly sprayed to the substrates W passing through the jet area RI formed in part of a pull-up passage PT (see FIG. 10), whereby the substrates W can be reliably dried. In this case, it follows that not a gas mixture but single gas, i.e., only IPA acts on the substrates W having been exposed to the high-temperature nitrogen gas so that the overall surfaces of the substrates W are covered with IPA. The low-concentration IPA vapor is efficiently supplied to the substrates W dried in the processing bath 120, whereby consumption of the IPA vapor can be reduced. In other words, the low-concentration IPA vapor is intensively supplied to a partial space in the chamber 110, whereby it follows that consumption of IPA can be remarkably reduced as compared with the conventional method supplying IPA vapor of constant concentration to the overall chamber 110.

When the substrates W pass through the jet area RI of the low-concentration IPA vapor, the first supply nozzles 140 stop supplying the IPA vapor.

When the substrates W further pulled up by the hoisting mechanism 130 thereafter reach the position shown by phantom lines in FIG. 10, the hoisting mechanism 130 is stopped to complete the operation of pulling up the substrates W. The substrates W pulled up to the position shown by phantom lines in FIG. 10 are transferred to the substrate transport robot and the series of processing is completed.

The substrates W held in the processing bath 120 having a smaller volume than the chamber 110 are supplied with the high-temperature nitrogen gas and pulled up to pass through the jet area RI of the IPA vapor which in turn is directly supplied to the substrates W due to the aforementioned operation of the substrate processing apparatus 201, whereby the substrates W can be quickly dried while reducing the quantity of IPA applying a load to the environment.

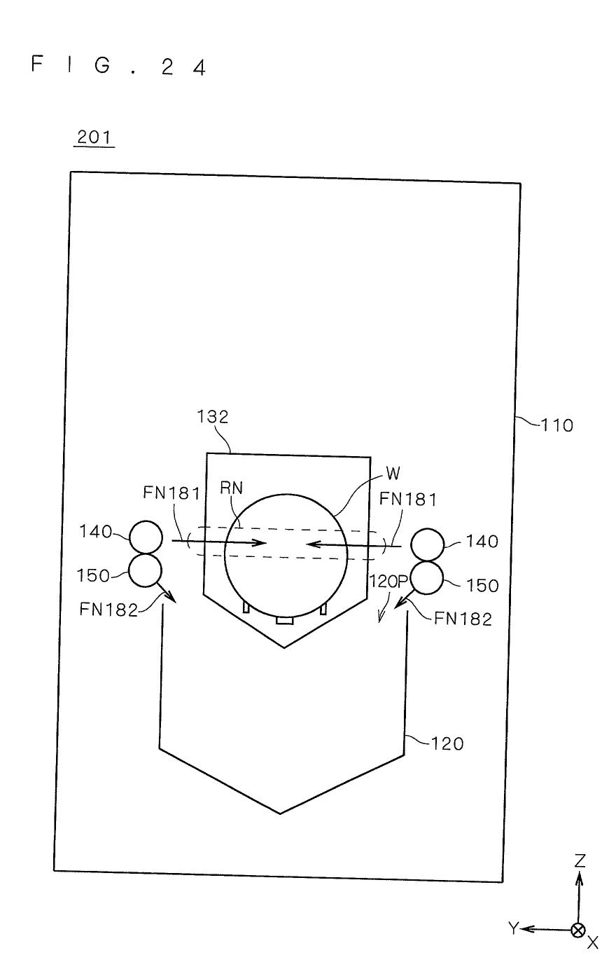

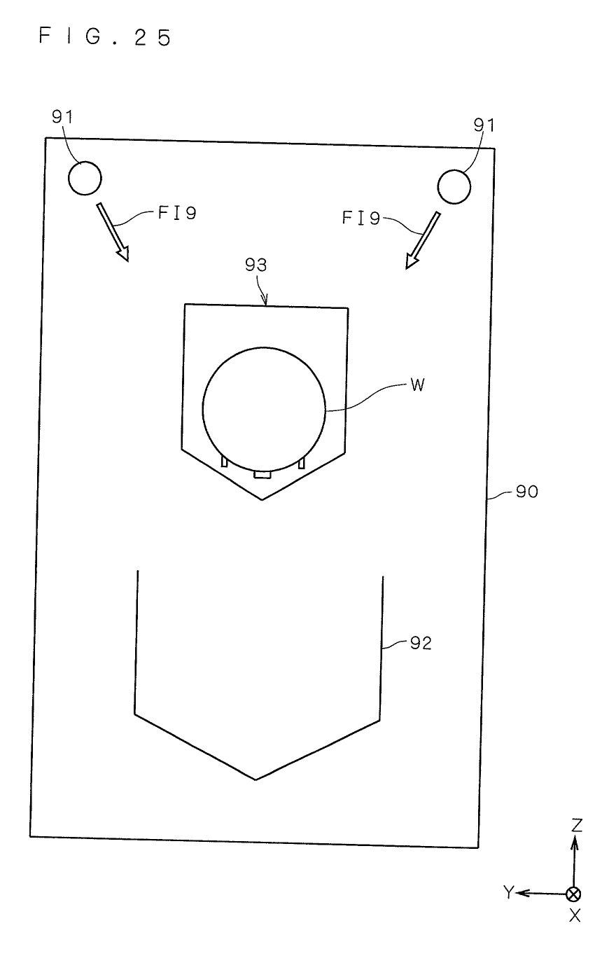

The substrate processing apparatus 201 may alternatively process the substrates W not along the aforementioned procedure but along the following procedure: In this procedure, it follows that the substrate processing apparatus 201 performs processing shown in FIG. 24 as that corresponding to the step S25 after the aforementioned steps S21 to S24 (see FIGS. 20 to 22).

In the processing shown in FIG. 24, the first supply nozzles 140 substantially horizontally discharge high-temperature nitrogen gas flows FN181 for forming a jet area RN of the nitrogen gas covering the opening 120p of the processing bath 120 while the second supply nozzles 150 discharge high-temperature nitrogen gas flows FN182 and introduce the same into the processing bath 120. The hoisting mechanism 130 is driven for pulling up the substrates W to pass through the jet area RN of the high-temperature nitrogen gas.

Thus, the high-temperature nitrogen gas is directly sprayed to the substrates W in the jet area RN of the high-temperature nitrogen gas formed in part of the pull-up passage PT (see FIG. 10), whereby it follows that the substrates W can be reliably dried after drying in the processing bath 120.

The substrates W held in the processing bath 120 having a smaller volume than the chamber 110 are supplied with the high-temperature nitrogen gas, pulled up to pass through the jet area RN of the high-temperature nitrogen gas and directly supplied with the high-temperature nitrogen gas due to the aforementioned procedure shown in FIGS. 20 to 22, whereby no IPA applying a load to the environment is required and no problem is caused in relation to disposal of IPA. Further, the substrates W can be prevented from residual of IPA, and the cost for the substrate processing apparatus 201 can be reduced.

In the aforementioned third embodiment, the high-temperature nitrogen gas may not necessarily be supplied into the chamber 110 but supply of high-temperature carbon dioxide gas may alternatively be started at the step S21 or S22 shown in FIG. 19. In other words, the term “inert gas” employed in this specification indicates gas poor in reactivity, and it follows that carbon dioxide gas is also included in “inert gas” in the broad sense.

While the invention has been shown and described in detail, the foregoing description is in all aspects illustrative and not restrictive. It is therefore understood that numerous modifications and variations can be devised without departing from the scope of the invention.

What is claimed is:

1. A substrate processing apparatus drying a substrate after cleaning said substrate with a fluid, comprising:
a processing bath storing a liquid for immersing said substrate in said liquid and cleaning said substrate;
holding device holding said substrate in said processing bath;
discharge device discharging said liquid stored in said processing bath while said holding device holds said substrate in said processing bath and inert gas is introduced into said processing bath; and
introduction device introducing an organic solvent into said processing bath while said holding device holds said substrate in said processing bath from which said liquid has been discharged by said discharge device.

2. The substrate processing apparatus according to claim 1, wherein
said introduction device has a discharge part provided in the vicinity of an opening of said processing bath for discharging said organic solvent toward said opening.

3. The substrate processing apparatus according to claim 2, wherein
said discharge part can also discharge inert gas.

4. The substrate processing apparatus according to claim 3, further comprising a chamber containing said processing bath.

5. The substrate processing apparatus according to claim 1, wherein
said organic solvent is vapor of isopropyl alcohol.

6. The substrate processing apparatus according to claim 1, wherein
said holding device collectively holds a plurality of substrates separated from each other.

7. The substrate processing apparatus according to claim 1, wherein
said inert gas is nitrogen gas.

8. A substrate processing method drying a substrate after cleaning said substrate with a fluid, comprising steps of:
(a) immersing said substrate in a liquid stored in a processing bath for cleaning said substrate;
(b) discharging said liquid stored in said processing bath while holding said substrate in said processing bath by holding device and introducing inert gas into said processing bath; and
(c) introducing an organic solvent into said processing bath while said holding device holds said substrate in said processing bath from which said liquid has been discharged.

9. The substrate processing method according to claim 8, further comprising a step of:
(d) introducing inert gas into said processing bath while said holding device holds said substrate in said processing bath from which said liquid has been discharged after said step (c).

10. The substrate processing method according to claim 8, wherein
said organic solvent is vapor of isopropyl alcohol.

11. The substrate processing method according to claim 9, wherein
said inert gas is nitrogen gas.

12. A substrate processing apparatus drying a substrate after cleaning said substrate with a fluid, comprising:
a processing bath storing a liquid for immersing said substrate in said liquid and cleaning said substrate;
holding device holding said substrate in said processing bath;
discharge device discharging said liquid stored in said processing bath while said holding device holds said substrate in said processing bath;
organic solvent supply device supplying an organic solvent for forming a jet area of said organic solvent on a position above said processing bath; and
pull-up device pulling up said substrate from said processing bath from which said liquid has been discharged by said discharge device and passing said substrate through said jet area of said organic solvent.

13. The substrate processing apparatus according to claim 12, further comprising inert gas introduction device introducing inert gas into said processing bath, wherein
said discharge device discharges said liquid stored in said processing bath while said inert gas introduction device introduces said inert gas into said processing bath.

14. The substrate processing apparatus according to claim 13, wherein
said organic solvent supply device has a discharge part provided in the vicinity of an opening of said processing bath for horizontally discharging said organic solvent on said position above said processing bath.

15. The substrate processing apparatus according to claim 13, wherein
a discharge part of said organic solvent supply device is provided above a discharge part of said inert gas introduction device.

16. The substrate processing apparatus according to claim 12, further comprising a chamber containing said processing bath.

17. The substrate processing apparatus according to claim 12, wherein
said organic solvent is vapor of isopropyl alcohol.

18. The substrate processing apparatus according to claim 12, wherein
said holding device collectively holds a plurality of substrates separated from each other.

19. The substrate processing apparatus according to claim 13, wherein
said inert gas is nitrogen gas.

20. The substrate processing apparatus according to claim 12, w herein
said jet area of said organic solvent is formed on part of a passage for pulling up said substrate with said pull-up device.

21. A substrate processing apparatus drying a substrate after cleaning said substrate with a fluid, comprising:
a processing bath storing a liquid for immersing said substrate in said liquid and cleaning said substrate;
holding device holding said substrate in said processing bath;
discharge device discharging said liquid stored in said processing bath while said holding device holds said substrate in said processing bath;
first supply device supplying an organic solvent to form a jet area of said organic solvent on a position above said processing bath;
second supply device introducing inert gas into said processing bath while said discharge device discharges said liquid stored in said processing bath; and
pull-up device pulling up said substrate from said processing bath from which said liquid has been discharged by said discharge device and passing said substrate through said jet area of said organic solvent.

22. The substrate processing apparatus according to claim 21, wherein
said first supply device has a discharge part provided in the vicinity of an opening of said processing bath for horizontally discharging said organic solvent on said position above said processing bath.

23. The substrate processing apparatus according to claim 21, wherein
said discharge part of said first supply device horizontally discharges inert gas on said position above said processing bath while said second supply device introduces said inert gas into said processing bath.

24. The substrate processing apparatus according to claim 21, wherein
said second supply device introduces said inert gas into said processing bath while said first supply device supplies said organic solvent.

25. The substrate processing apparatus according to claim 21, wherein
said discharge part of said first supply device supplies inert gas after supplying said organic solvent.

26. The substrate processing apparatus according to claim 21, wherein
a discharge part of said first supply device is provided above a discharge part of said second supply device.

27. The substrate processing apparatus according to claim 21, further comprising a chamber containing said processing bath.

28. The substrate processing apparatus according to claim 21, wherein
said organic solvent is vapor of isopropyl alcohol.

29. The substrate processing apparatus according to claim 21, wherein
said holding device collectively holds a plurality of substrates separated from each other.

30. The substrate processing apparatus according to claim 21, wherein
said inert gas is nitrogen gas.

31. The substrate processing apparatus according to claim 21, wherein
said jet area of said organic solvent is formed on part of a passage for pulling up said substrate with said pull-up device.

32. A substrate processing method drying a substrate after cleaning said substrate with a fluid, comprising steps of:
(a) immersing said substrate in a liquid stored in a processing bath for cleaning said substrate;
(b) discharging said liquid stored in said processing bath while holding said substrate in said processing bath by holding device;
(c) supplying an organic solvent for forming a jet area of said organic solvent on a position above said processing bath; and
(d) pulling up said substrate from said processing bath from which said liquid has been discharged by said discharge device to pass said substrate through said jet area of said organic solvent.

33. The substrate processing method according to claim 32, wherein
said liquid stored in said processing bath is discharged while introducing inert gas into said processing bath in said step (b).

34. The substrate processing method according to claim 32, further comprising a step of supplying inert gas to said substrate after said step (d).

35. The substrate processing method according to claim 33, wherein
first supply device supplies said organic solvent for forming said jet area of said organic solvent on said position above said processing bath in said step (c), and
said liquid stored in said processing bath is discharged while second supply device different from said first supply device introduces said inert gas into said processing bath in said step (b).

36. The substrate processing method according to claim 35, wherein
said second supply device introduces said inert gas into said processing bath while said first supply device horizontally supplies inert gas on said position above said processing bath in said step (b).

37. The substrate processing method according to claim 36, further comprising a step of horizontally supplying inert gas by said first supply device on said position above said processing bath after said step (d).

38. The substrate processing method according to claim 36, wherein
said organic solvent is vapor of isopropyl alcohol.

39. The substrate processing method according to claim 36, wherein
said inert gas is nitrogen gas.

40. A substrate processing apparatus drying a substrate after cleaning said substrate with a fluid, comprising:
a processing bath storing a liquid for immersing said substrate in said liquid and cleaning said substrate;
holding device holding said substrate in said processing bath;
discharge device discharging said liquid stored in said processing bath while said holding device holds said substrate in said processing bath;
heating device heating inert gas supplied from an inert gas source for generating high-temperature inert gas; and
inert gas introduction device introducing inert gas into said processing bath while said holding device holds said substrate in said processing bath from which said liquid has been discharged by said discharge device.

41. The substrate processing apparatus according to claim 40, wherein
said discharge device discharges said liquid stored in said processing bath while said inert gas introduction device introduces said high-temperature inert gas into said processing bath.

42. The substrate processing apparatus according to claim 41, wherein
said inert gas introduction device has a discharge part provided in the vicinity of an opening of said processing bath for discharging said high-temperature inert gas toward said opening.

43. The substrate processing apparatus according to claim 40, further comprising a chamber containing said processing bath.

44. The substrate processing apparatus according to claim 43, further comprising decompression device decompressing said chamber when said inert gas supply device supplies said high-temperature inert gas.

45. The substrate processing apparatus according to claim 41, further comprising inert gas jet area forming device discharging high-temperature inert gas on a position above said processing bath for forming a jet area of said high-temperature inert gas in an opening of said processing bath.

46. The substrate processing apparatus according to claim 45, further comprising pull-up device pulling up said substrate from said processing bath from which said liquid has been discharged by said discharge device and passing said substrate through said jet area of said high-temperature inert gas.

47. The substrate processing apparatus according to claim 41, wherein
a discharge part of said inert gas jet area forming device is provided above a discharge part of said inert gas introduction device.

48. The substrate processing apparatus according to claim 46, wherein
said jet area of said high-temperature inert gas is formed on part of a passage for pulling up said substrate with said pull-up device.

49. The substrate processing apparatus according to claim 41 , further comprising:
organic solvent supply device supplying an organic solvent for forming a jet area of said organic solvent on a position above said processing bath, and
substrate pull-up device pulling up said substrate from said processing bath from which said liquid has been discharged by said discharge device and passing said substrate through said jet area of said organic solvent.

50. The substrate processing apparatus according to claim 49, wherein
a discharge part of said organic solvent supply device is provided above a discharge part of said inert gas introduction device.

51. The substrate processing apparatus according to claim 49, wherein
said jet area of said organic solvent is formed on part of a passage for pulling up said substrate with said pull-up device.

52. The substrate processing apparatus according to claim 40, wherein
an organic solvent is vapor of isopropyl alcohol.

53. The substrate processing apparatus according to claim 40, wherein
said holding device collectively holds a plurality of substrates separated from each other.

54. The substrate processing apparatus according to claim 40, wherein
said inert gas is nitrogen gas.

55. A substrate processing apparatus drying a substrate after cleaning said substrate with a fluid, comprising:
a processing bath storing a liquid for immersing said substrate in said liquid and cleaning said substrate;
holding device holding said substrate in said processing bath;
discharge device discharging said liquid stored in said processing bath while said holding device holds said substrate in said processing bath;
first supply device supplying high-temperature inert gas on a position above said processing bath to form a jet area of said high-temperature inert gas in an opening of said processing bath; and
second supply device introducing inert gas into said processing bath while said discharge device discharges said liquid stored in said processing bath.

56. The substrate processing apparatus according to claim 55, wherein
said first supply device has a discharge part provided in the vicinity of said opening of said processing bath for horizontally discharging said high-temperature inert gas on said position above said processing bath.

57. The substrate processing apparatus according to claim 56, wherein
said discharge part of said first supply device horizontally discharges said high-temperature inert gas on said position above said processing bath when said second supply device introduces said inert gas into said processing bath.

58. The substrate processing apparatus according to claim 55, wherein
a discharge part of said first supply device is provided above a discharge part of said second supply device.

59. The substrate processing apparatus according to claim 56, wherein
said discharge part of said first supply device supplies said high-temperature inert gas on said position above said processing bath to form said jet area of said high-temperature inert gas on said position above said processing bath and thereafter supplies an organic solvent on said position above said processing bath to form a jet area of said organic solvent on a position above said opening of said processing bath.

60. The substrate processing apparatus according to claim 55, further comprising a chamber containing said processing bath.

61. The substrate processing apparatus according to claim 60, further comprising decompression device decompressing said chamber when said first supply device supplies said high-temperature inert gas.

62. The substrate processing apparatus according to claim 59, further comprising pull-up device pulling up said substrate from said processing bath from which said liquid has been discharged by said discharge device and passing said substrate through said jet area of said organic solvent.

63. The substrate processing apparatus according to claim 62, wherein
said jet area of said organic solvent is formed on part of a passage for pulling up said substrate with said pull-up device.

64. The substrate processing apparatus according to claim 59, wherein
an organic solvent is vapor of isopropyl alcohol.

65. The substrate processing apparatus according to claim 55, wherein
said holding device collectively holds a plurality of substrates separated from each other.

66. The substrate processing apparatus according to claim 55, wherein
said inert gas is nitrogen gas.

67. A substrate processing method drying a substrate after cleaning said substrate with a fluid, comprising steps of:
(a) immersing said substrate in a liquid stored in a processing bath for cleaning said substrate;
(b) discharging said liquid stored in said processing bath while holding said substrate in said processing bath by holding device; and
(c) introducing high-temperature inert gas formed by heating inert gas supplied to said processing bath from an inert gas source into said processing bath while said holding device holds said substrate in said processing bath discharged.

68. The substrate processing method according to claim 67, wherein
said liquid stored in said processing bath is discharged while introducing high-temperature inert gas into said processing bath in said step (b).

69. The substrate processing method according to claim 68, wherein
said step (c) includes a step of decompressing a chamber containing said processing bath when introducing said high-temperature inert gas into said processing bath.

70. The substrate processing method according to claim 68, wherein
said step (c) includes a step of horizontally supplying said high-temperature inert gas on a position above said processing bath for forming a jet area of said high-temperature inert gas covering an opening of said processing bath.

71. The substrate processing method according to claim 70, wherein
first supply device horizontally supplies said high-temperature inert gas on said position above said processing bath and second supply device different from said first supply device introduces said high-temperature inert gas into said processing bath in said step (c).

72. The substrate processing method according to claim 70, further comprising steps of:
(d) horizontally supplying an organic solvent on a position above said processing bath for forming a jet area of said organic solvent covering an opening of said processing bath, and
(e) pulling up said substrate from said processing bath from which said liquid has been discharged by said discharge device and passing said substrate through said jet area of said organic solvent after said step (c).

73. The substrate processing method according to claim 72, wherein
first supply device horizontally supplies said organic solvent on said position above said processing bath in said step (d), and
second supply device different from said first supply device introduces said high-temperature inert gas into said processing bath in said step (c).

74. The substrate processing method according to claim 72, further comprising a step of horizontally supplying inert gas on said position above said processing bath after said step (e).

75. The substrate processing method according to claim 72, wherein
said organic solvent is vapor of isopropyl alcohol.

76. The substrate processing method according to claim 67, wherein
said inert gas is nitrogen gas.

77. The substrate processing method according to claim 68, wherein
said step (c) includes a step of horizontally supplying said high-temperature inert gas on a position above said processing bath for forming a jet area of said high-temperature inert gas covering an opening of said processing bath,
said substrate processing method further comprising steps of:
(f) horizontally supplying an organic solvent on said position above said processing bath for forming a jet area of said organic solvent covering said opening of said processing bath,
(g) pulling up said substrate from said processing bath from which said liquid has been discharged by said discharge device and passing said substrate through said jet area of said organic solvent, and
(h) horizontally supplying high-temperature inert gas to said substrate on said position above said processing bath after said step (c).

78. The substrate processing method according to claim 77, wherein
first supply device supplies said high-temperature inert gas in said step (h) and supplies said organic solvent in said step (f), and
second supply device different from said first supply device introduces said high-temperature inert gas into said processing bath in said step (c).
